(19) United States
(12) Patent Application Publication
(10) Pub. No.: US 2026/0333280 A1
(43) Pub. Date: Oct. 22, 2026

(54) ENHANCING POSITIONING MEASUREMENT ACCURACY WITH CARRIER AGGREGATION

(71) Applicant: Nokia Technologies Oy, Espoo (FI)

(72) Inventors: Satya Krishna JOSHI, Oulu (FI); Muhammad Ikram ASHRAF, Espoo (FI); Ryan KEATING, Naperville, IL (US); Hyun-Su CHA, Naperville, IL (US); Daejung YOON, Nozay (FR)

(21) Appl. No.: 19/115,592

(22) PCT Filed: Sep. 6, 2023
(86) PCT No.: PCT/EP2023/074408

§ 371 Date: Mar. 26, 2025

Related U.S. Application Data
(60) Provisional application No. 63/377,448, filed on Sep. 28, 2022.

(51) Int. Cl. H04W 64/00

(52) U.S. Cl. CPC H04W 64/00

(57) ABSTRACT

Example embodiments of the present disclosure relate to devices, methods, apparatuses and computer readable media for enhancing positioning measurement accuracy with carrier aggregation. A first device in a communication network may be configured to receive from a second device in the communication network a first positioning reference signal on a first component carrier and a second positioning reference signal on a second component carrier, and to jointly process the first positioning reference signal and the second positioning reference signal to generate a positioning measurement in response to an over-sampling indication indicative of over-sampling being applied to positioning reference signals.

### TECHNICAL FIELD

Various example embodiments described herein generally relate to communication technologies, and more particularly, to devices, methods, apparatuses and computer readable media for enhancing positioning measurement accuracy with carrier aggregation.

### BACKGROUND

Certain abbreviations that may be found in the description and/or in the figures are herewith defined as follows:
CA Carrier Aggregation
CC Component Carrier
gNB next Generation Node-B
IFFT Inverse Fast Fourier Transform
LMC Location Management Component
LMF Location Management Function
LTE Long Term Evolution
LPP LTE Positioning Protocol
Multi-RTT Multi-cell Round Trip Time
NR New Radio
NRPPa NR Positioning Protocol A
OFDM Orthogonal Frequency Division Multiplexing
PRS Positioning Reference Signal
RRC Radio Resource Control
SRS Sounding Reference Signal
TRP Transmission Reception Point
UE User Equipment

Terrestrial network based positioning methods can be broadly categorized into timing based methods, angle based methods and hybrid timing-angle based methods. The timing based methods rely on propagation delay of radio frequency (RF) carriers for estimation of distances between a user equipment (UE) and multiple base stations or transmission reception points (TRPs) and utilize the trilateration principle to determine position of the UE. Similarly, the triangulation principle is applied for the angle based methods by exploiting knowledge of transmit signal beamforming and/or phase differences across receiving antenna elements to determine azimuth and zenith angles between a transmitter and a pair of receivers.

### SUMMARY

A brief summary of exemplary embodiments is provided below to provide basic understanding of some aspects of various embodiments. It should be noted that this summary is not intended to identify key features of essential elements or define scopes of the embodiments, and its sole purpose is to introduce some concepts in a simplified form as a preamble for a more detailed description provided below.

In a first aspect, an example embodiment of a first device in a communication network is provided. The first device may comprise at least one processor and at least one memory storing instructions. The instructions may, when executed by the at least one processor, cause the first device at least to receive from a second device in the communication network a first positioning reference signal on a first component carrier and a second positioning reference signal on a second component carrier, and to jointly process the first positioning reference signal and the second positioning reference signal to generate a positioning measurement in response to an over-sampling indication indicative of over-sampling being applied to positioning reference signals.

In a second aspect, an example embodiment of a second device in a communication network is provided. The second device may comprise at least one processor and at least one memory storing instructions. The instructions may, when executed by the at least one processor, cause the second device at least to over-sample a first positioning reference signal and a second positioning reference signal in response to an over-sampling indication indicative of over-sampling being applied to positioning reference signals, and to transmit to a first device in the communication network the first positioning reference signal on a first component carrier and the second positioning reference signal on a second component carrier.

In a third aspect, an example embodiment of a location server in a communication network is provided. The location server may comprise at least one processor and at least one memory storing instructions. The instructions may, when executed by the at least one processor, cause the location server at least to transmit an over-sampling indication indicative of over-sampling being applied to positioning reference signals to at least one of a network device or a terminal device in the communication network.

Example embodiments of methods, apparatus and computer readable media are also provided. Such example embodiments generally correspond to the example embodiments in the above aspects and a repetitive description thereof is omitted here for convenience.

Other features and advantages of the example embodiments of the present disclosure will also be apparent from the following description of specific embodiments when read in conjunction with the accompanying drawings, which illustrate, by way of example, the principles of example embodiments of the present disclosure.

### BRIEF DESCRIPTION OF THE DRAWINGS

Some example embodiments will now be described, by way of non-limiting examples, with reference to the accompanying drawings.

FIG. 1 is a schematic diagram illustrating an example wireless communication network in which example embodiments of the present disclosure can be implemented.

FIGS. 2A and 2B are block diagrams illustrating transmit architecture options for carrier aggregation.

FIG. 3 is a message flow diagram illustrating a positioning procedure according to an example embodiment of the present disclosure.

FIG. 4 is a schematic diagram illustrating over-sampling of positioning reference signals according to an example embodiment of the present disclosure.

FIG. 5 is a process flow diagram illustrating a method for jointly processing positioning reference signals according to an example embodiment of the present disclosure.

FIG. 6 is a schematic diagram illustrating an example frequency shift process according to an example embodiment of the present disclosure.

FIG. 7 is a process flow diagram illustrating a method for phase offset compensation according to an example embodiment of the present disclosure.

FIG. 8 is a process flow diagram illustrating a method for carrier phase estimation according to an example embodiment of the present disclosure.

FIG. 9 is a process flow diagram illustrating a method for carrier phase estimation according to an example embodiment of the present disclosure.

FIG. 10 is a process flow diagram illustrating a method for determining phase compensation factors according to an example embodiment of the present disclosure.

FIG. 11 is a message flow diagram illustrating a positioning procedure according to an example embodiment of the present disclosure.

FIG. 12 is a schematic block diagram illustrating an apparatus according to an example embodiment of the present disclosure.

FIG. 13 is a schematic block diagram illustrating an apparatus according to an example embodiment of the present disclosure.

FIG. 14 is a schematic block diagram illustrating an apparatus according to an example embodiment of the present disclosure.

FIG. 15 is a schematic block diagram illustrating a communication system according to an example embodiment of the present disclosure.

Throughout the drawings, same or similar reference numbers indicate same or similar elements. A repetitive description on the same elements would be omitted.

### DETAILED DESCRIPTION

Herein below, some example embodiments are described in detail with reference to the accompanying drawings. The following description includes specific details for the purpose of providing a thorough understanding of various concepts. However, it will be apparent to those skilled in the art that these concepts may be practiced without these specific details. In some instances, well known circuits, techniques and components are shown in block diagram form to avoid obscuring the described concepts and features.

As used herein, the term “terminal device” may refer to any entities or devices that can wirelessly communicate with network devices or with each other. Examples of the terminal device can include a mobile phone, a mobile terminal (MT), a mobile station (MS), a subscriber station (SS), a portable subscriber station (PSS), an access terminal (AT), a computer, a wearable device, an on-vehicle communication device, a machine type communication (MTC) device, a D2D communication device, a V2X communication device, a sensor and the like. The term “terminal device” can be used interchangeably with a user equipment (UE), a user terminal, a mobile terminal, a mobile station, or a wireless device.

As used herein, the term “network device” may refer to any suitable entities or devices that can provide cells or coverage, through which the terminal devices can access the network or receive services. The network device may be commonly referred to as a base station. The term “base station” used herein can represent a node B (NodeB or NB), an evolved node B (eNodeB or eNB), or a gNB. The base station may be embodied as a macro base station, a relay node, or a low power node such as a pico base station or a femto base station. The base station may consist of several distributed network units, such as a central unit (CU), one or more distributed units (DUs), one or more remote radio heads (RRHs) or remote radio units (RRUs). The number and functions of these distributed units depend on the selected split RAN architecture.

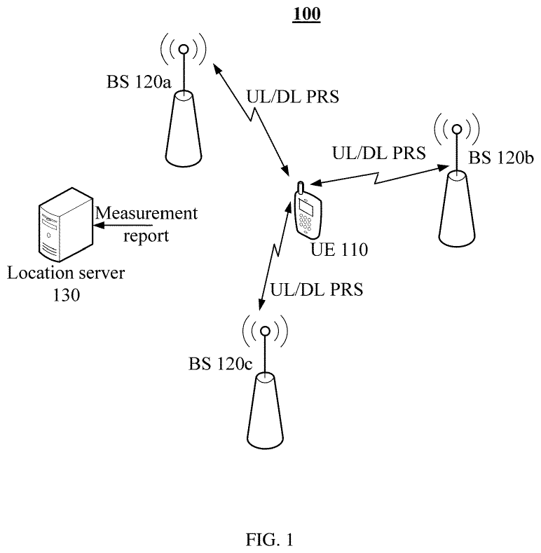

FIG. 1 illustrates an example communication network 100 in which example embodiments of the present disclosure can be implemented. As shown in FIG. 1, the communication network 100 may include a plurality of base stations (BSs) 120 (three base stations 120a, 120b and 120c are shown as an example), which may form a so-called radio access network (RAN) and provide network access to a plurality of user equipments (UEs) 110. FIG. 1 shows one UE 110, which may connect to any one of the plurality of base stations 120. In an example, the UE 110 may camp in a cell supported by the base station 120a and establish a radio resource control (RRC) connection with the base station 120a. The base station 120a may be referred to as a serving base station for the UE 110, and the base stations 120b, 120c may be referred to as neighboring base stations.

In some example embodiments, the communication network 100 may employ a multiple transmission reception point (mTRP) architecture where the UE 110 can transmit data to and receive data from one or more transmission reception points (TRPs). The TRPs may be associated with one or more base stations 120 and/or one or more cells. Example embodiments described herein are not limited to any particular deployment of the TRPs or a particular relationship between the TRPs and the base stations/cells. It would be appreciated that throughout the present disclosure, the term “base station” may also comprise a TRP, and operations performed at a base station may be performed at least partially at a TRP.

The communication network 100 may further comprise a location server 130 to manage positioning of UEs connected to the network 100. The location server 130 may be a physical or logical entity, which may be implemented as a local location management component (LMC) in the RAN or as a location management function (LMF) in the core network. As mentioned above, the timing based positioning methods, the angle based positioning methods or the hybrid timing-angle based positioning methods may be performed in the communication network 100 to estimate the position of the UE 110. In these positioning methods, the UE 110 may transmit a positioning reference signal (PRS) to the base stations 120 in uplink (UL) and/or receive a positioning reference signal transmitted from the base stations 120 in downlink (DL). The base stations 120 and the UE 110 may measure the UL PRS and the DL PRS respectively to estimate time or angle of arrival (TOA or AOA) of the received PRS and send a positioning measurement report including the TOA or AOA estimation to the location server 130. The location server 130 may estimate the position of the UE 110 based on the received positioning measurement reports.

A continuous goal of the positioning methods is to improve the positioning measurement accuracy. Rel. 18 has approved a study item for positioning with an objective to improve the positioning accuracy based on carrier aggregation (CA) (also known as bandwidth aggregation). In 5G New Radio (NR), CA can support up to 16 contiguous or non-contiguous component carriers (CCs) and aggregate 5G bands up to approximately 1 GHz of spectrum. Usually, CA is considered for data transmission, not for transmission of reference signals like PRS. In the CA based data transmission, data symbols are scheduled/processed independently in respective CCs, and it is sufficient to improve the overall throughput by aggregating the respective CCs. In case of the CA based reference signal (e.g., PRS) transmission, however, increasing the length of PRS symbols just by scheduling and processing the PRS symbols independently in respective CCs (as in the CA based data transmission) is not enough, because this strategy does not exploit the overall sequence length gain. If the respective CCs are processed independently in case of PRS, gain can come from averaging not the increase in bandwidth. Furthermore, the diversity gain from multiple CCs may be marginal, especially for large frequency separation between two CCs. Thus, to improve the accuracy of the positioning measurements, joint processing of the PRS sequences scheduled in different CCs is required. The LMF may configure two or more PRS resources across different CCs.

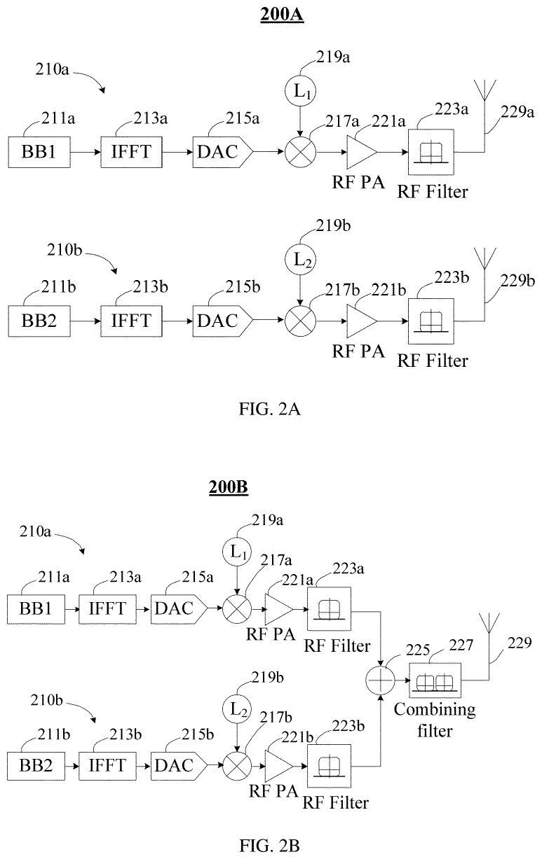

Joint processing of PRS sequences received on different CCs depends on the transmit (Tx) and receive (Rx) architectures for CA, and the error and noise sources they possess. FIGS. 2A and 2B illustrate two Tx architecture options for CA in an orthogonal frequency division multiplexing (OFDM) system, and similar architecture options at the receiver side are conceivable. Referring to FIG. 2A first, the Tx architecture 200A may include two separate RF chains 210a, 210b to support two contiguous or non-contiguous CCs. The first RF chain 210a may include a first baseband (BB) 211a, a first inverse fast Fourier transform (IFFT) block 213a, a first digital to analog converter (DAC) 215a, a first mixer 217a, a first local oscillator 219a, a first RF power amplifier (PA) 221a, a first RF filter 223a and a first antenna 229a. The first baseband 211a may provide a baseband signal, which is a lowpass signal generated from information source. The first IFFT block 213a may perform IFFT transformation on the baseband signal to convert it from the frequency domain to the time domain, and the first DAC 215a may convert the baseband signal from the digital domain to the analog domain. The first mixer 217a, also known as modulator, may modulate a carrier provided from the local oscillator 219a with the analog baseband signal and provide the modulated signal to the first RF power amplifier 221a where the modulated signal may be amplified. The RF filter 223a may remove out-of-band component of the amplified modulated signal and generate a passband signal that has its frequency spectrum concentrated around the carrier frequency. Then the passband signal is transmitted via the first antenna 219a. Similar to the first RF chain 210a, the second RF chain 210b may include a second baseband 211b, a second IFFT block 213b, a second DAC 215b, a second mixer 217b, a second local oscillator 219b, a second RF PA 221b, a second RF filter 223b and a second antenna 229b, which can process a second baseband signal provided from the second baseband 211b in a similar way as in the first RF chain 210a.

Referring to FIG. 2B, in the Tx architecture 200B, output of the first RF filter 223a in the first RF chain 210a and output of the second RF filter 223b in the second RF chain 210b may be combined at a RF combiner 225 and filtered in a combining filter 227. Then the combined signal may be transmitted via a shared antenna 219. Other aspects of the Tx architecture 200B may be similar to the Tx architecture 200A and a repetitive description is omitted here. It would be appreciated that other Tx/Rx architectures for CA are also possible where RF chains for respective CCs include one or more different hardware components.

The need or use of different hardware components in RF chains supporting different component carriers introduces various problems, e.g., timing errors, phase coherence, frequency errors, etc. Timing/phase offsets among the CCs would lead to inter-CC symbol interference while positioning reference signals (PRSs) transmitted in different CCs are jointly processed. If the timing/phase offsets among the CCs are not compensated or mitigated, simply joint processing of the PRS sequences scheduled in different CCs would result in poor/inaccurate positioning time-delay estimation due to the inter-CC symbol interference. In other words, simply increasing the PRS transmission bandwidth using multiple CCs is not enough to improve the accuracy of positioning measurements, if timing/phase offsets among the CCs are not treated and joint processing of the PRSs scheduled/configured in different CCs are not performed.

According to aspects of the present disclosure, a procedure to improve the accuracy of positioning measurements by jointly processing PRS sequences scheduled in different CCs is provided. At the transmitter side, taking into account the aggregated CCs bandwidth, PRS sequences may be over-sampled in the time domain before they are transmitted via multiple CCs. At the receiver side, oversampling is also performed as indicated by the transmitter or by a location server, and then timing/phase offsets among the CCs may be corrected/compensated, and the PRS sequences transmitted via different CCs may be jointly processed to generate a single positioning measurement. The inter-CC symbol interference can be eliminated/mitigated during joint processing of the PRS sequences, and accuracy of the positioning measurement can be improved. The procedure can achieve a true performance gain by the carrier aggregation.

A frequency flat channel with a dominate line of sight (LOS) path may be considered for the PRS transmissions. With this assumption, a raw channel Hₗ can be estimated by multiplying the received signal in the l-th subcarrier and the conjugate of the PRS symbol scheduled in the l-th subcarrier. The channel frequency response (CFR) of the channel Hₗ may be approximated as follows:

H₁≈(α₁ sinc(±Δ)e^{-j2πf}^{_{c}}^{τ}^{₁})(e^{-j2πf}^{₁}^{(τ}^{₁}^{±ΔT}^{ₛ}⁾) (1).

In the above equation (1), a₁ is the path gain, and τₗ is the propagation delay of the dominate LOS path (i.e., the first arrival path). The notation Δ is used to denote a normalized quantization error of the propagation delay τₗ which is normalized to the sampling period Tₛ that depends on the transmission bandwidth. The function sinc( ) is used as a scaling factor that depends on pulse shape, and an ideal pulse shape may be assumed to ease the approximation. As shown in the equation (1), the carrier phase “2πf_{c}τₗ” is independent of the CC bandwidth, while the actual delay “τₗ+ΔTₛ” is quantized depending on the CC bandwidth.

To estimate the propagation delay, an IFFT operation may be performed on the channel frequency response. Assuming that two CCs each having a bandwidth N (N is the number of subcarriers) are aggregated and there is no timing/phase offset between the two CCs, the IFFT-processed channel frequency response (CFR) may be expressed as follows:

$$h [ n \overline{{T}_{s}} ] = ( {α}_{1} sinc ( \pm Δ ) {e}^{- j 2 π {f}_{c} {τ}_{1}} ) {{\sum }_{k = 0}}^{M - 1} {e}^{j 2 π {f}_{k} ( n \overline{{T}_{s}} - ( {τ}_{1} \pm Δ {T}_{s} ) ) ,} \qquad ( 2 )$$

where n is the number of sampling points, T̅ₛ is the sampling period (or resolution) obtained by joint processing (i.e., IFFT-processing) the two CCs, and M is the IFFT size which may be set larger than or at least equal to the aggregated CCs bandwidth 2N (i.e., M≥2N). It is assumed that the two CCs have the same bandwidth N to simplify the discussion, and example embodiments described below are also applicable to CCs with unequal bandwidth.

In the above equation (2), the item “τₗ+ΔTₛ” depends on the CC bandwidth N, and the item “nT̅ₛ” depends on the aggregated CCs bandwidth 2N. The equation (2) shows that simply jointly processing the two CCs (which increases the resolution T̅ₛ) is not sufficient to improve accuracy of the delay measurement, if the transmitter/receiver does not take into account the aggregated CCs bandwidth while transmitting/receiving the PRS sequences in the respective CCs. The resolution Tₛ in each CC also needs to be increased Therefore, over-sampling of the PRS sequences transmitted/received at each CC is required.

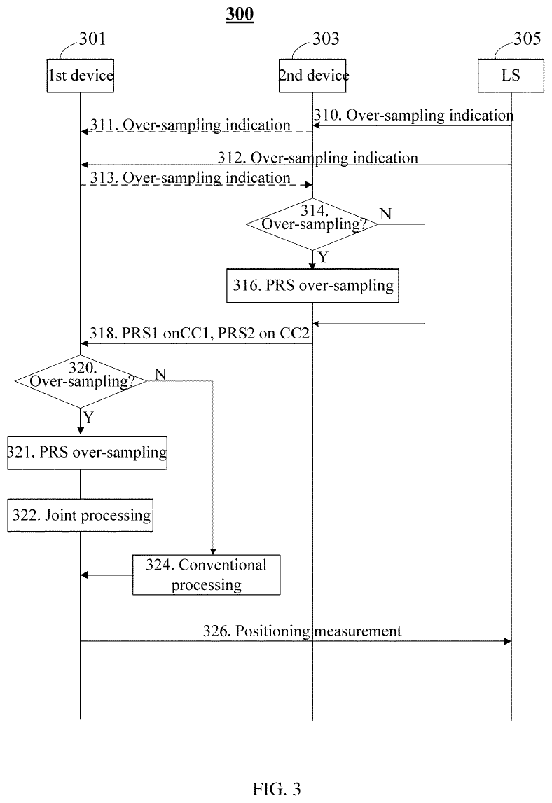

FIG. 3 is a message flow chart illustrating a positioning procedure 300 according to an example embodiment of the present disclosure. As shown in FIG. 3, steps in the positioning procedure 300 may be performed at a first device 301, a second device 303 and a location server (LS) 305. The first device 301 may be implemented as a terminal device like the UE 110 shown in FIG. 1, and the second device 303 may be implemented as a network device like any one of the base stations 120 shown in FIG. 1. In another example embodiment, the first device 301 may be implemented as a network device like any one of the base stations 120 shown in FIG. 1, and the second device 303 may be implemented as a terminal device like the UE 110 shown in FIG. 1. The location server 305 may be implemented as the location server 130 shown in FIG. 1. As discussed above, the location server 305 may be implemented as a location management function (LMF) in the core network or a location management component (LMC) in the RAN.

Referring to FIGS. 3, at 310 and 312, the location server 305 may transmit an over-sampling indication to the second device 303 and the first device 301, respectively. For example, the location server 305 may transmit the over-sampling indication via an LTE Positioning Protocol (LPP) message to one of the first device 301 and the second device 303 which is implemented as the UE 110 and via an NR Positioning Protocol a (NRPPa) message to the other of the first device 301 and the second device 303 which is implemented as the base station 120. In an example embodiment where the first device 301 is implemented as the UE 110 and the second device 303 is implemented as the base station 120, the second device 303 may transmit the over-sampling indication received from the location server 305 to the first device 301 via RRC signaling at 311, and the step 312 may be omitted. In an example embodiment where the first device 301 is implemented as the base station 120 and the second device 303 is implemented as the UE 110, the first device 301 may transmit the over-sampling indication received from the location server 305 to the second device 303 via RRC signaling at 313, and the step 310 may be omitted.

The over-sampling indication may indicate whether over-sampling is applied to positioning reference signals (PRSs). For example, the over-sampling indication may include an information element (IE) like “PRSCCoverSample” with a value “True” or “False” to indicate whether over-sampling is applied to DL PRS. Alternatively or additionally, the over-sampling indication may include an IE like “SRSCCoverSample” with a value “True” or “False” to indicate whether over-sampling is applied to sounding reference signals.

Throughout the present disclosure, the term “positioning reference signal” or “PRS” may refer to any UL or DL reference signal which can be used to perform positioning measurement, unless the context otherwise requires. Examples of the UL reference signals for positioning measurement may include but not be limited to sounding reference signal (SRS), physical random-access channel (PRACH), UL demodulation reference signal (DMRS), UL phase tracking reference signal (PTRS), and other UL reference signals which can be used for UL positioning as defined in 3GPP specifications. Examples of the DL reference signals for positioning measurement may include but not be limited to the so-called positioning reference signal defined in 3GPP specifications, synchronization signal block (SSB), channel state information reference signal (CSI-RS), DL DMRS, and other DL reference signals which can be used for DL positioning as defined in 3GPP specifications. In some example embodiments, for convenience of description, the PRS and SRS defined in 3GPP specifications are described as examples of DL PRS and UL PRS, respectively, but aspects of the present disclosure are also applicable to other positioning reference signals.

In an example embodiment, the over-sampling indication may further include information of an over-sampling factor for over-sampling the PRSs. The location server 305 may determine the over-sampling factor for the CCs and signal the determined over-sampling factor to the first device 301 and the second device 303. The over-sampling factor may be at least equal to the overall aggregated CCs bandwidth. In another example, the location server 305 may inform the first device 301 and the second device 303 of the aggregated CCs bandwidth, from which the first device 301 and the second device 303 can derive the required over-sampling factor for the respective CCs. In yet another example, the first device 301 and the second device 303 may be aware of the overall aggregated CCs bandwidth, and the location server 305 does not need to explicitly or implicitly signal the over-sampling factor to the first device 301 and the second device 303.

If the second device 303 determines at 314 from the over-sampling indication received at 310 that over-sampling is applied to PRSs, the second device 303 may determine that the PRSs transmitted on multiple CCs would be jointly processed at the receiver side, and it may perform over-sampling on the PRSs in the time domain at 316. In this regard, the over-sampling indication may also be referred to as a receiver to perform over-sampling and joint-processing indication. For convenience of description, two PRSs to be transmitted on two CCs are described here as an example. The second device 303 may over-sample a first PRS (PRS1) to be transmitted on a first CC (CC1) and a second PRS (PRS2) to be transmitted on a second CC (CC2) based on the over-sampling factor at the step 316.

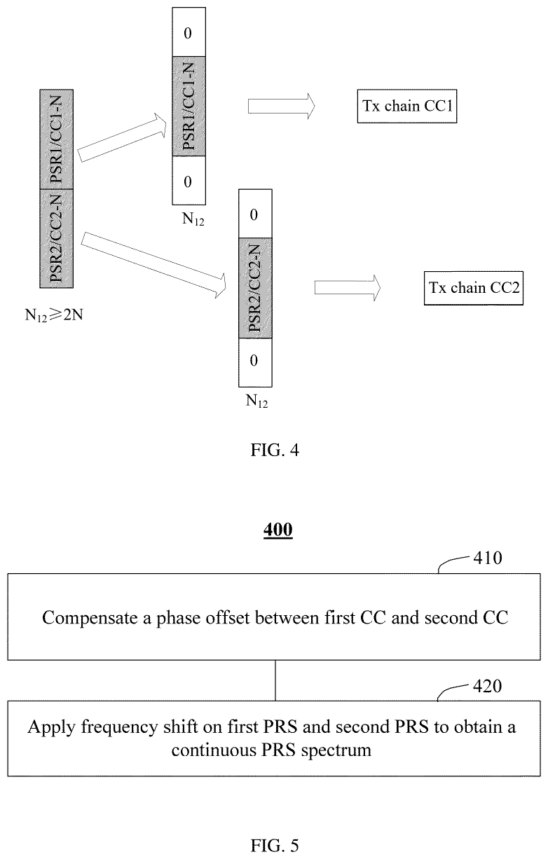

FIG. 4 shows an example over-sampling operation according to an example embodiment of the present disclosure. Referring to FIG. 4, it is assumed that the first component carrier CC1 and the second component carrier CC2 each has a bandwidth N (i.e., the number of subcarriers), and the over-sampling factor N₁₂ is larger than or equal to the overall aggregated CCs bandwidth 2N, i.e., N₁₂≥2N. The second device 303 may pad zeros to resource elements at either side of the first positioning reference signal PRS1 and the second positioning reference signal PRS2 in the frequency domain until the first positioning reference signal PRS1 and the second positioning reference signal PRS2 each is expanded to a bandwidth indicated by the over-sampling factor N₁₂. Then the first positioning reference signal PRS1 may be processed in a first Tx chain and transmitted on the first component carrier CC1, the second positioning reference signal PRS2 may be processed in a second Tx chain and transmitted on the second component carrier CC2. In terms of spectrum use, the zero-padding in the frequency domain does not produce any affect because nothing is transmitted in the additional subcarriers of either side where zero is added, but when the expanded first and second positioning reference signals PRS1, PRS2 are IFFT-processed in the Tx chains, the zero-padding would result in more sample points in the time domain, which helps to improve positioning measurement accuracy at the receiver side as discussed above with respect to the equation (2). It would be appreciated that the zero-padding in the frequency domain is an example for over-sampling the PRSs in the time domain, and other approaches for over-sampling are also applicable in the example embodiments.

Referring back to FIG. 3, if over-sampling is not applied to the PRSs at 314, the second device 303 may determine that the PRSs transmitted on multiple CCs would be independently processed at the receiver side, and it may process the PRSs to be transmitted in a conventional way.

At 318, the second device 303 may transmit the first positioning reference signal PRS1 on the first component carrier CC1 and the second positioning reference signal PRS2 on the second component carrier CC2 to the first device 301. If the second device 303 is implemented as a network device (e.g., a base station) and the first device 301 is implemented as a terminal device (e.g., a UE), the first positioning reference signal PRS1 and the second positioning reference signal PRS2 may be DL PRSs, e.g., the PRS defined in 3GPP specifications. If the second device 303 is implemented as the terminal device and the first device 301 is implemented as the network device, the first positioning reference signal PRS1 and the second positioning reference signal PRS2 may be UL PRSs, e.g., sounding reference signals (SRSs). Although not shown, the second device 303 may also indicate to the first device 301 whether the first positioning reference signal PRS1 and the second positioning reference signal PRS2 have been over-sampled or not.

At 320, the first device 301 may determine based on the over-sampling indication received from the location server 305 or the second device 303 whether over-sampling is applied to PRSs. If over-sampling is applied, the first device 301 may over-sample the received time-domain PRS1 and PRS2 signals at 321. The over-sampling may be performed in the same way as at the transmitter side, i.e., by zero-padding in the frequency domain as discussed above with respect to FIG. 4 followed by the IFFT processing to obtain more samples in the time domain. A repetitive description of the over-sampling at the receiver side is omitted here for convenience.

Then at 322, the first device 301 may jointly process the first positioning reference signal PRS1 received on the first component carrier CC1 and the second positioning reference signal PRS2 received on the second component carrier CC2 to generate a single positioning measurement at 322. The positioning measurement may include a time of arrival (TOA) estimation, a carrier phase estimation, an angle of arrival (AOA) estimation or the like, depending the positioning scheme implemented in the network. In this approach, the PRS sequence length gain can be achieved by carrier aggregation (CA), and the positioning measurement can have improved accuracy.

If the first device 301 determines at 320 that over-sampling is not applied, the first device 301 may process the first positioning reference signal PRS1 and the second positioning reference signal PRS2 in a conventional way at 324. For example, the first device 301 may process the first positioning reference signal PRS1 and the second positioning reference signal PRS2 independently to save its processing power, and generate two positioning measurements.

At 326, the first device 301 may report the positioning measurement(s) to the location server 305. The location server 305 may estimate a position of the first device 301 based on a plurality of positioning measurement reports received from the first device 301 and position coordinates of multiple related second devices 303. In an example embodiment, the first device 301 may additionally report whether the UE obtained the positioning measurement(s) by joint processing or not, and the UE may further report CC index(es) with the positioning measurements, so that the location server 305 knows the reported positioning measurements are obtained from the reported CC index(es).

FIG. 5 illustrates a method 400 for jointly processing PRSs received on different CCs according to an example embodiment of the present disclosure. The method 400 may be performed by the first device 301 at the step 322 in the method 300 shown in FIG. 3.

Referring to FIG. 5, at 410, the first device 301 may compensate a phase offset between the first component carrier CC1 carrying the first positioning reference signal PRS1 and the second component carrier CC2 carrying the second positioning reference signal PRS2. As discussed above, the first and second component carriers CC1, CC2 may be affected by different/independent timing/phase errors, and the timing/phase offset between the first and second component carriers CC1, CC2 has to be corrected/compensated to estimate the propagation delay, otherwise the bandwidth expansion using carrier aggregation may not improve the accuracy of the propagation delay estimation. Details of the phase offset compensation will be described below.

At 420, the first device 301 may apply frequency shift in baseband on the first positioning reference signal PRS1 received on the first component carrier CC1 and the second positioning reference signal PRS2 received on the second component carrier CC2. The frequency shift of the first positioning reference signal PRS1 and the second positioning reference signal PRS2 by exploiting the property of IFFT can remove the frequency-domain spacing between the PRS1 and the PRS2 caused by white space between non-contiguous CC1 and CC2 or a guard band between contiguous CC1 and CC2 and generate a continuous PRS spectrum in baseband from the received first positioning reference signal PRS1 and second positioning reference signal PRS2. It can reduce the IFFT window size required for jointly processing the PRS1 and the PRS2 and thus reduce the IFFT complexity.

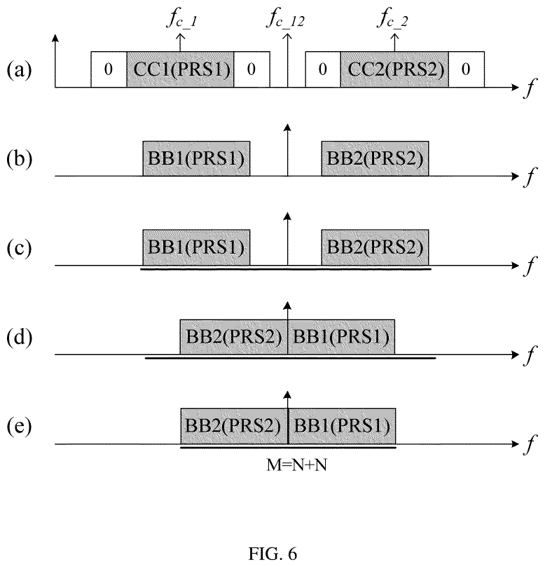

FIG. 6 is a schematic diagram illustrating an example frequency shift process in baseband to combine PRSs received in different component carriers according to an example embodiment of the present disclosure. Referring to FIG. 6(a) first, there is shown the first positioning reference signal PRS1 to be transmitted on the first component carrier CC1 and the second positioning reference signal PRS2 to be transmitted on the second component carrier CC2 at the transmitter side (e.g., at the second device 303). The first component carrier CC1 has a first central frequency f_{c_1}, and the second component carrier CC2 has a second central frequency f_{c_2}. As discussed above, the first positioning reference signal PRS1 and the second positioning reference signal PRS2 are over-sampled by zero-padding at either side. FIG. 6(a) also shows a passband central frequency f_{c_12} of the signal bandwidth from CC1 to CC2, which may be determined as f_{c_12}=(f_{c_1}+f_{c_2})/2. When the PRS1 and the PRS2 are jointly processed at the receiver side, the passband central frequency f_{c_12} may correspond to the direct current (DC) frequency in baseband.

FIG. 6(b) shows the first positioning reference signal PRS1 and the second positioning reference signal PRS2 in baseband received at the receiver side (e.g., at the first device 301). The first positioning reference signal PRS1 is processed in a first baseband BB1, and the second positioning reference signal PRS2 is processed in a second baseband BB2. As discussed above, the first positioning reference signal PRS1 and the second positioning reference signal PRS2 may have been affected by different timing/phase errors associated with the first component carrier CC1 and the second component carrier CC2.

In FIG. 6(c), the timing/phase offset between the first component carrier CC1 and the second component carrier CC2 is corrected/compensated, e.g., at the step 410 in the method 400 shown in FIG. 5. However, due to the white space or guard band between the first component carrier CC1 and the second component carrier CC2, a relatively large IFFT window size is still required for joint processing of the first positioning reference signal PRS1 and the second positioning reference signal PRS2, as shown by a thick solid line in FIG. 6(c).

Referring to FIG. 6(d), frequency shift may be applied in baseband to remove spacing between the first positioning reference signal PRS1 and the second positioning reference signal PRS2 in the frequency domain by exploiting the property of IFFT. In an example embodiment, a new central frequency may be determined and the frequency shift may be applied at the new central frequency. For example, as shown in FIG. 6(d), the DC frequency (the vertical arrow) may be treated as the central frequency, the first positioning reference signal PRS1 and the second positioning reference signal PRS2 may be frequency-shifted so that they concatenate with each other at the central frequency, generating a continuous PRS sequence spectrum including the PRS1 and the PRS2. The frequency shift removes the spacing between the PRS1 and the PRS2 caused by the white space of guard band between the first component carrier CC1 and the second component carrier CC2, generating the continuous PRS sequence spectrum in baseband from the received first positioning reference signal PRS1 and second positioning reference signal PRS2. The continuous PRS sequence spectrum may be used for subsequent joint processing of the first positioning reference signal PRS1 and the second positioning reference signal PRS2.

It would be appreciated that the central frequency may also be determined as other frequencies, and the frequency shift may also be applied in other ways. For example, referring to FIG. 6(c), when the DC frequency (the vertical arrow) is treated as the central frequency, a band from the first symbol of the first positioning reference signal PRS1 to the DC frequency may be shifted so that the first symbol of the first positioning reference signal PRS1 concatenates with the last symbol of the second positioning reference signal PRS2. The thus generated continuous PRS sequence spectrum has a position relative to the DC frequency different from that shown in FIG. 6(d), but the difference would not impact the power delay profile (PDP) and the path delay estimation.

In FIG. 6(e), the edge white space at either side of the continuous PRS sequence spectrum may be ignored, and hence the IFFT window size M may be reduced to M=2N for joint IFFT processing of the first positioning reference signal PRS1 and the second positioning reference signal PRS2 (i.e., the continuous PRS sequence spectrum). In an example embodiment, a further frequency shift may be applied to the concatenated PRS1 and PRS2 (as shown in FIG. 6(e)) so that the first symbol of the PRS2 in BB2 is at the DC frequency (i.e., considered as the DC part for IFFT) (not shown in FIG. 6). The IFFT window size determines complexity of the propagation delay estimation algorithm with carrier aggregation. The proposed process can reduce the complexity of the propagation delay estimation algorithm by eliminating the spectrum spacing between the first positioning reference signal PRS1 and the second positioning reference signal PRS2 and reducing the IFFT window size. In addition, the joint processing of the first positioning reference signal PRS1 and the second positioning reference signal PRS2 can recover a single PRS sequence for the propagation delay estimation, which can improve accuracy of the propagation delay estimation by exploiting the overall sequence length gain with carrier aggregation.

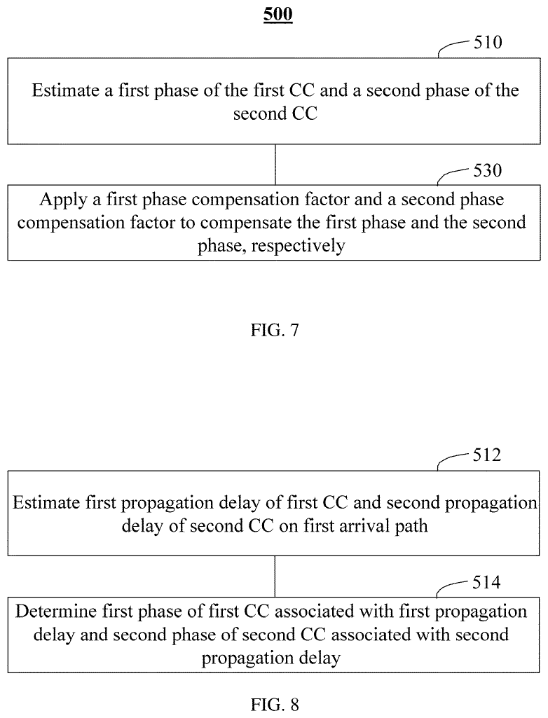

FIG. 7 is a process flow diagram illustrating a method 500 for phase offset compensation according to an example embodiment of the present disclosure. The method 500 may be performed by the first device 301 at the step 410 in the method 400 shown in FIG. 5.

Before describing the method 500, the reason for performing the phase offset compensation will be discussed. In the above equation (2), it is assumed that there is no timing/phase offset between the first component carrier CC1 and the second component carrier CC2, but it would not happen in practice when the first component carrier CC1 and the second component carrier CC2 are transmitted via different RF chains including at least one hardware component. When the timing/phase offset between the first component carrier CC1 and the second component carrier CC2 is considered, the equation (2) may be re-written as follows:

$$h [ n \overline{{T}_{s}} ] = ( {α}_{1} sinc ( \pm \hat{Δ} ) {e}^{- j ( 2 π {f}_{c} \hat{{τ}_{1}} - \hat{{ϕ}_{0}} )} ) {\sum }_{l = 0}^{N - 1} {e}^{j 2 π {f}_{l} ( n \overline{{T}_{s}} - ( \hat{{τ}_{1}} \pm \hat{Δ} {T}_{s} ) )} + ( {α}_{1} sinc ( \pm \tilde{Δ} ) {e}^{- j ( 2 π {f}_{c} \tilde{{τ}_{1}} - \tilde{{ϕ}_{0}} ) )} {\sum }_{k = N}^{2 N - 1} {e}^{j2 π {f}_{k} ( n \overline{{T}_{s}} - ( \tilde{{τ}_{1}} \pm \tilde{Δ} {T}_{s} ) )} . \qquad ( 3 )$$

In the equation (3), φ₀ denotes an initial phase of the positioning reference signal at the transmitter, and it may be determined by the initial phase of the local oscillator in the RF chain, the timing alignment error (TAE), etc. The “hat” (\hat{ }) and “tilde” (~) notations are used in the equation (3) to represent different parameter values for the first component carrier CC1 including subcarriers from l=0 to l=(N−1) and the second component carrier CC2 including subcarriers from k=N to K=(2N−1). It can be seen from the equation (3) that the difference in common phase (2π*f_{c}*τ₁−φ₀) between the first component carrier CC1 and the second component carrier CC2 would cause inter-CC symbol interference when the first component carrier CC1 and the second component carrier CC2 are jointly processed, which has an adverse impact on the accuracy of the positioning measurement. Therefore, the timing/phase offset between the first component carrier CC1 and the second component carrier CC2 needs to be corrected/compensated.

Referring to FIG. 7, at 510, the first device 301 may estimate a first phase θ₁ of the first component carrier CC1 and a second phase θ₂ of the second component carrier CC2. At 530, the first device 301 may apply a first phase compensation factor to compensate the first phase θ₁ of the first component carrier CC1 and apply a second phase compensation factor to compensate the second phase θ₂ of the second component carrier CC2, thereby compensating the timing/phase offset between first component carrier CC1 and the second component carrier CC2.

FIG. 8 is a process flow diagram illustrating steps for estimating the first phase θ₁ of the first component carrier CC1 and the second phase θ₂ of the second component carrier CC2 according to an example embodiment of the present disclosure. As shown in FIG. 8, at 512, the first device 301 may estimate a first propagation delay \hat{τ}₁ of the first component carrier CC1 and a second propagation delay \tilde{τ}₁ of the second component carrier CC2 on a first arrival path (e.g., the LOS path) from the second device 303 to the first device 301. For example, the first device 301 may perform an IFFT operation (see the equation (3)) on channel estimation of each component carrier, or correlate receiver (Rx) PRS with transmitter (Tx) PRS on each component carrier in the frequency domain or in the time domain. Then the first device 301 can look into the power delay profile (PDP) and estimate the first arrival path and corresponding propagation delay of the component carrier. The power delay profile gives a distribution of signal power received over multiple paths as a function of propagation delays, and usually the first arrival path (e.g., the LOS path) corresponds to the maximum signal power.

At 514, the first device 301 may determine the first phase θ₁ of the first component carrier CC1 associated with the first propagation delay \hat{τ}₁ and the second phase θ₂ of the second component carrier CC2 associated with the second propagation delay \tilde{τ}₁. It can be understood that, as shown in the above equation (3), the determined carrier phase actually includes the phase rotation 2πf_{c} τ₁ due to the propagation delay τ₁ and the initial phase φ₀ at the transmitter side, i.e., θ₂=2πf_{c_1}\hat{τ}₁−\hat{φ}₀, θ₂=2πf_{c_2}\tilde{τ}₁−\tilde{φ}₀ where f_{c_1} and f_{c_2} are the central frequencies of the first component carrier CC1 and the second component carrier CC2, respectively.

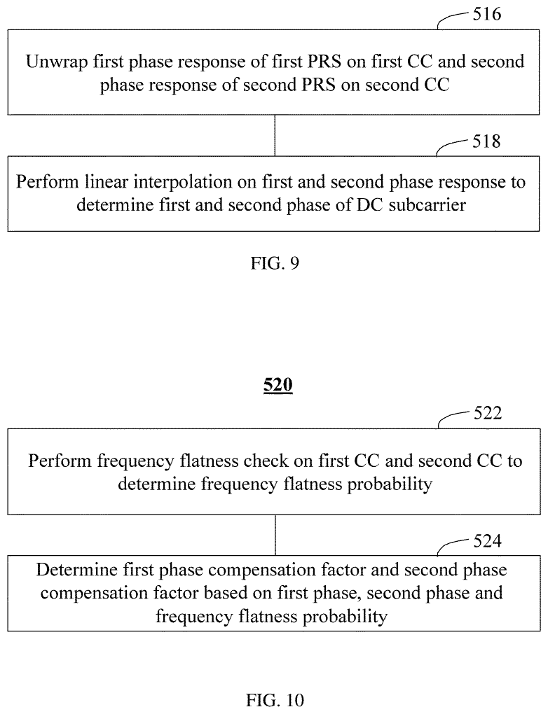

FIG. 9 illustrates another method for estimating the first phase θ₁ of the first component carrier CC1 and the second phase θ₂ of the second component carrier CC2 according to an example embodiment of the present disclosure, which utilize the principle that, in the frequency domain, the carrier phase is associated with the direct current (DC) subcarrier of the component carrier which has the central frequency f_{c}, as shown in the equation (3). The PRS symbol may be forced to be transmitted on the DC subcarrier, and no other signal is scheduled on the DC subcarrier. The phase of the DC subcarrier may be determined as the carrier phase.

As shown in FIG. 9, at 516, the first device 301 may unwrap, in the frequency domain, a first phase response of the first positioning reference signal PRS1 received on the first component carrier CC1 and a second phase response of the second positioning reference signal PRS2 received on the second component carrier CC2. In this case, the DC subcarrier of the first component carrier CC1 is configured for the first positioning reference signal PRS1, on which no other signal is scheduled. The DC subcarrier of the second component carrier CC2 is configured for the second positioning reference signal PRS2, on which no other signal is scheduled. The unwrap operation makes the phase response continuous across 2π discontinuities by adding or subtracting appropriate multiples of 2π radians as needed. Then at 518, the first device 301 may perform linear interpolation on the unwrapped first and second phase response to determine the phase of the DC subcarrier (i.e., the frequency f_{c_1}) of the first component carrier CC1 as the first phase θ₁ of the first component carrier CC1, and to determine the phase of the DC subcarrier (i.e., the frequency f_{c_2}) of the second component carrier CC2 as the second phase θ₂ of the first component carrier CC1. Compared with the method shown in FIG. 8, the method shown in FIG. 9 has reduced complexity.

FIG. 10 is a process flow diagram illustrating a method 520 for determining phase compensation factors according to an example embodiment of the present disclosure. The method 520 may be performed by the first device 301 before the step 530 in the method 500 shown in FIG. 7.

Referring to FIG. 10, at 522, the first device 301 may perform frequency flatness check/testing on the first component carrier CC1 and the second component carrier CC2 to determine a frequency flatness probability. The frequency flatness check may be performed by counting the number of channels with a channel gain over a channel threshold, and the frequency flatness probability may be expressed by a percentage defined as follows:

Frequency flatness percentage=1−C_{fading}/total number of channels C_{fading}=number of channels with abs(Hₗ)<H_{threshold} (4),

where Hₗ is the l-th channel, the function abs (Hₗ) returns magnitude of the l-th channel, H_{threshold} is a predetermined channel gain threshold, and C_{fading} is the number of fading channels with a channel gain lower than the channel gain threshold H_{threshold}. The frequency flatness probability/percentage indicates an overall channel quality of the first component carrier CC1 and the second component carrier CC2.

At 524, the first device 301 may determine the first phase compensation factor for compensating the first phase θ₁ of the first component carrier CC1 and the second phase compensation factor for compensating the second phase θ₂ of the second component carrier CC2 based on the first phase θ₁, the second phase θ₂ and the determined frequency flatness probability/percentage. In an example, the phase compensation factors may be determined as follows:

If Frequency flatness percentage≥Frequency flatness threshold:

First phase compensation factor for CC1=−θ₁

Second phase compensation factor for CC2=−θ₂

else:

First phase compensation factor for CC1=−θ₁−θ_{avg}

Second phase compensation factor for CC2=−θ₂−θ_{avg} (5),

where θ_{avg} is an average carrier phase of the aggregated component carriers, i.e., θ_{avg}=(θ₁+θ₂)/2, and Frequency flatness threshold is a threshold configured by the location server 305 or a network device/base station serving the first device 301 when the first device 301 is implemented as a terminal device/UE. As shown in the above equation (5), when the frequency flatness percentage is higher than or equal to the frequency flatness threshold, the phase compensation factor may be set to a negative value of the carrier phase of each component carrier. When the frequency flatness percentage is lower than the frequency flatness threshold, the phase compensation factor may be set to a negative value of a sum of the carrier phase of the component carrier and the average carrier phase of the aggregated component carriers.

When the phase compensation factors for the first component carrier CC1 and the second component carrier CC2 have been determined, the first device 301 may apply the phase compensation factors to compensate the carrier phases θ₁, θ₂ of the first component carrier CC1 and the second component carrier CC2, e.g., in the step 530 of the method 500 shown in FIG. 7. The phase compensation may be expressed as follows:

If Frequency flatness percentage>Frequency flatness threshold:

CC1 phase compensation, Ĥ′ₗ=Ĥₗe^{-j(-θ}^{₁}⁾

CC2 phase compensation, \tilde{H}′ₗ=\tilde{H}ₗe^{-j(-θ}^{₂}⁾

else:

CC1 phase compensation, Ĥ′ₗ=Ĥₗe^{-j(-θ}^{₁}^{-θ}^{_{avg}}⁾

CC1 phase compensation, \tilde{H}′ₗ=\tilde{H}ₗe^{-j(-θ}^{₂}^{-θ}^{_{avg}}⁾ (6),

where Ĥₗ and \tilde{H}ₗ are the l-th channel estimation of the first component carrier CC1 and the second component carrier CC2, respectively.

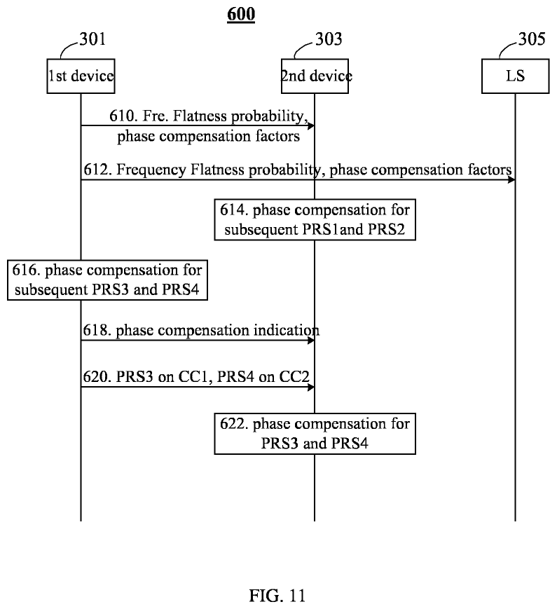

FIG. 11 illustrate a positioning procedure 600 according to an example embodiment of the present disclosure. The procedure 600 may be performed by the first device 301, the second device 303 and the location server 305 when the first device 301 has determined the phase compensation factors for jointly processing the first positioning reference signal PRS1 received on the first component carrier CC1 and the second positioning reference signal PRS2 received on the second component carrier CC2. In the procedure 600, the first device 301 may signal at least one of the frequency flatness probability or the applied phase compensation factors to the second device 303 and/or the location server 305. In case of multi-RTT positioning, the second device 303 may use the phase compensation factors for subsequent PRS transmissions and/or receptions. The second device 303 may also use the frequency flatness probability to determine validity of the phase compensation factors over time, e.g., in next X slots or subframes where X is a positive integer determined based on the frequency flatness probability. The location server 305 may use the frequency flatness probability to evaluate a confidence level of the positioning measurements relating to the first device 301.

Referring to FIG. 11, at 610, the first device 301 may report, e.g., via RRC signaling, at least one of the frequency flatness probability or the applied phase compensation factors for the component carriers to the second device 303. At 612, the first device 301 may report, e.g., via an LPP message, at least one of the frequency flatness probability or the applied phase compensation factors for the component carriers to the location server 305.

At 614, the second device 303 may apply the received phase compensation factors for subsequent transmissions of the first positioning reference signal PRS1 on the first component carrier CC1 and the second positioning reference signals PRS2 on the second component carrier CC2. It can reduce the timing/phase offset between the first component carrier CC1 and the second component carrier CC2 from the transmitter side and then the receiver (i.e., the first device 301) can iteratively determine the phase compensation factors for the component carriers to improve phase compensation accuracy and thus the positioning measurement accuracy.

In an example, the second device 303 may determine validity of the received phase compensation factors based on the frequency flatness probability. If the frequency flatness probability has a high percentage value, the second device 303 may apply the phase compensation factors to subsequent positioning reference signals PRS1, PRS2 in more slots or subframes. If the frequency flatness probability has a small percentage value, the second device 303 may apply the phase compensation factors in less slots or subframes, or the second device 303 may not apply the phase compensation factors.

At 616, in case of multi-RTT positioning, the first device 301 may apply the first phase compensation factor of the first component carrier CC1 to a third positioning reference signal PRS3 to be transmitted on the first component carrier CC1, and apply the second phase compensation factor of the second component carrier CC2 to a fourth positioning reference signal PRS4 to be transmitted on the second component carrier CC2. It would be appreciated that the first device 301 and the second device 303 may operate in a time division duplexing (TDD) mode where the first component carrier CC1 and the second component carrier CC2 each comprises both downlink and uplink slots. If the first device 301 is implemented as a terminal device and the second device 303 is implemented as a network device, the first and second positioning reference signals PRS1, PRS2 may be downlink positioning reference signals, the third and fourth positioning reference signals PRS3, PRS4 may be uplink sounding reference signals (SRSs). If the first device 301 is implemented as a network device and the second device 303 is implemented as a terminal device, the first and second positioning reference signals PRS1, PRS2 may be uplink sounding reference signals (SRSs), the third and fourth positioning reference signals PRS3, PRS4 may be downlink positioning reference signals.

At 618, the first device 301 may send a phase compensation indication to the second device 303. The phase compensation indication may indicate whether the third and fourth positioning reference signals PRS3, PRS4 to be transmitted to the second device 303 have been phase-compensated or not.

At 620, the first device 301 may transmit the third positioning reference signal PRS3 on the first component carrier CC1 and the fourth positioning reference signal PRS4 on the second component carrier CC2 to the second device 303. Although not shown in FIG. 11, the first device 301 may also over-sample the third positioning reference signal PRS3 and the fourth positioning reference signal PRS4 based on an over-sampling indication received from the second device 303 or the location server 305, before transmitting the third positioning reference signal PRS3 on the first component carrier CC1 and the fourth positioning reference signal PRS4 on the second component carrier CC2.

At 622, the second device 303 may perform phase compensation on the received third positioning reference signal PRS3 and fourth positioning reference signal PRS4, if the phase compensation indication received in the step 618 indicates that the phase offset between the third positioning reference signal PRS3 and the fourth positioning reference signal PRS4 is not compensated at the first device 301. The phase compensation step 622 may be similar to the phase compensation step 530 performed at the first device 301 in the method 500 shown in FIG. 7, and a repetitive description is omitted here for convenience. If the phase compensation indication received in the step 618 indicates that the first device 301 has compensated the phase offset between the third positioning reference signal PRS3 and the fourth positioning reference signal PRS4, the step 622 may be omitted.

Although not shown in FIG. 11, the second device 303 may jointly process the third positioning reference signal PRS3 and the fourth positioning reference signal PRS4 to obtain a single PRS sequence. Then the second device 303 may estimate a round trip delay time and report the round trip delay time estimation to the location server 305.

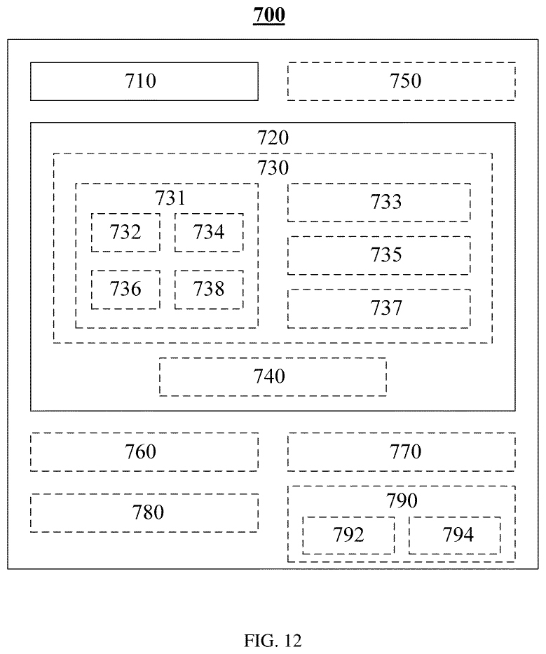

FIG. 12 is a schematic block diagram illustrating an apparatus 700 according to an example embodiment of the present disclosure. The apparatus 700 may be implemented to comprise or to form at least a part of the first device 301 discussed above to perform operations related to the first device 301. Since the operations related to the first device 301 have been discussed above with reference to FIGS. 1-11, the blocks of the apparatus 700 will be described briefly here and details thereof may refer to the above description.

Referring to FIG. 12, the apparatus 700 may include a first means 710 for receiving at the first device 301 from the second device 303 a first positioning reference signal PRS1 on a first component carrier CC1 and a second positioning reference signal PRS2 on a second component carrier CC2, and a second means 720 for jointly processing the first positioning reference signal PRS1 and the second positioning reference signal PRS2 to generate a positioning measurement in response to an over-sampling indication indicative of over-sampling being applied to positioning reference signals.

In an example embodiment, the first device 301 is a terminal device, and the second device 303 is a network device. In this case, the first positioning reference signal PRS1 and the second positioning reference signal PRS2 are downlink positioning reference signals. The over-sampling indication may be received from the location server 305 or from the second device 303.

In an example embodiment, the first device 301 is a network device, and the second device 303 is a terminal device. In this case, the first positioning reference signal PRS1 and the second positioning reference signal PRS2 are sounding reference signals, the over-sampling indication may be received from the location server 305.

In an example embodiment, the over-sampling indication may further comprise information of an over-sampling factor for the first positioning reference signal PRS1 and the second positioning reference signal PRS2. In an example, the over-sampling factor may be equal to an overall bandwidth obtained by aggregating the first component carrier CC1 and the second component carrier CC2.

In an example embodiment, the second means 720 may include a first sub-means 730 for compensating a phase offset between the first component carrier CC1 and the second component carrier CC2, and a second sub-means 740 for applying frequency shift on the first positioning reference signal PRS1 and the second positioning reference signal PRS2 to obtain a continuous positioning reference signal spectrum in baseband from the received first positioning reference signal PRS1 and the received second positioning reference signal PRS2. In an example, the second sub-means 740 may apply the frequency shift to concatenate the first positioning reference signal PRS1 and the second positioning reference signal PRS2 at a central frequency f_{c_12} between the first positioning reference signal PRS1 and the second positioning reference signal PRS2 in the frequency domain. When the frequency shift is applied, white space or a guard band between the first component carrier CC1 and the second component carrier CC2 is removed.

In an example embodiment, the first sub-means 730 may include a first unit 731 for estimating a first phase θ1 of the first component carrier CC1 and a second phase θ2 of the second component carrier CC2, and a second unit 733 for applying a first phase compensation factor to compensate the first phase θ1 of the first component carrier CC1 and a second phase compensation factor to compensate the second phase θ2 of the second component carrier CC2.

In an example embodiment, the first unit 731 may include a first sub-unit 732 for estimating a first propagation delay of the first component carrier CC1 and a second propagation delay of the second component carrier CC2 on a first arrival path (e.g., the LOS path) from the second device 303 to the first device 301, and a second sub-unit 734 for determining the first phase θ1 of the first component carrier CC1 associated with the first propagation delay and the second phase θ2 of the second component carrier CC2 associated with the second propagation delay.

In an example embodiment, the first unit 731 may include a third sub-unit 736 for unwrapping in the frequency domain, a first phase response of the first positioning reference signal PRS1 and a second phase response of the second positioning reference signal PRS2. In this case, a first direct current (DC) subcarrier of the first component carrier CC1 is configured for the first positioning reference signal PRS1 and no other signal is scheduled on the first DC subcarrier. A second DC subcarrier of the second component carrier CC2 is configured for the second positioning reference signal PRS2 and no other signal is scheduled on the second DC subcarrier. The first unit 731 may further include a fourth sub-unit 738 for performing linear interpolation on the first phase response and the second phase response to determine the first phase θ1 corresponding to the first DC subcarrier of the first component carrier CC1 as the first phase of the first component carrier CC1 and the second phase θ2 corresponding to the second DC subcarrier of the second component carrier CC2 as the second phase of the second component carrier CC2.

In an example embodiment, the first sub-means 730 may further include a third unit 735 for performing a frequency flatness check on the first component carrier CC1 and the second component carrier CC2 to determine a frequency flatness probability, and a fourth unit 737 for determining the first phase compensation factor and the second phase compensation factor at least based on the first phase θ1 of the first component carrier CC1, the second phase θ2 of the second component carrier CC2 and whether the frequency flatness probability is higher than or equal to a threshold. The threshold may be configured from the second device 303 when the first device 301 is a terminal device and the second device 303 is a network device serving the terminal device, or from the location server 305.

In an example embodiment, the apparatus 700 may further include a third means 750 for reporting at least one of the frequency flatness probability, the first phase compensation factor for the first component carrier CC1, or the second phase compensation factor for the second component carrier CC2 to at least one of the second device 303 or the location server 305.

In an example embodiment, the apparatus 700 may further include a fourth means 760 for applying the first phase compensation factor and the second phase compensation factor to compensate a third positioning reference signal PRS3 and a fourth positioning reference signal PRS4, respectively, and a fifth means 770 for transmitting to the second device 303 the compensated third positioning reference signal PRS3 on the first component carrier CC1 and the compensated fourth positioning reference signal PRS4 on the second component carrier CC2. In an example, the first positioning reference signal PRS1 and the second positioning reference signal PRS2 may be downlink positioning reference signals, and the third positioning reference signal PRS3 and the fourth positioning reference signal PRS4 may be uplink sounding reference signals. In another example, the first positioning reference signal PRS1 and the second positioning reference signal PRS2 may be uplink sounding reference signals, and the third positioning reference signal PRS3 and the fourth positioning reference signal PRS4 may be downlink positioning reference signals.

In an example embodiment, the apparatus 700 may further include a sixth means 780 for informing the second device 303 of the phase compensation made to the third positioning reference signal PRS3 and the fourth positioning reference signal PRS4.

In an example embodiment, the apparatus 700 may further include a seventh means 790 for over-sampling in the time domain the first positioning reference signal PRS1 received on the first component carrier CC1 and the second positioning reference signal PRS2 received on the second component carrier CC2 in response to the over-sampling indication, before the first positioning reference signal PRS1 and the second positioning reference signal PRS2 are jointly processed.

In an example embodiment, the seventh means 790 may include a first sub-means 792 for zero-padding resource elements at either side of the first positioning reference signal PRS1 and the second positioning reference signal PRS2 in the frequency domain to at least a bandwidth indicated by the over-sampling factor, and a second sub-means for converting the zero-padded first positioning reference signal PRS1 and the zero-padded second positioning reference signal PRS2 from the frequency domain to the time domain.

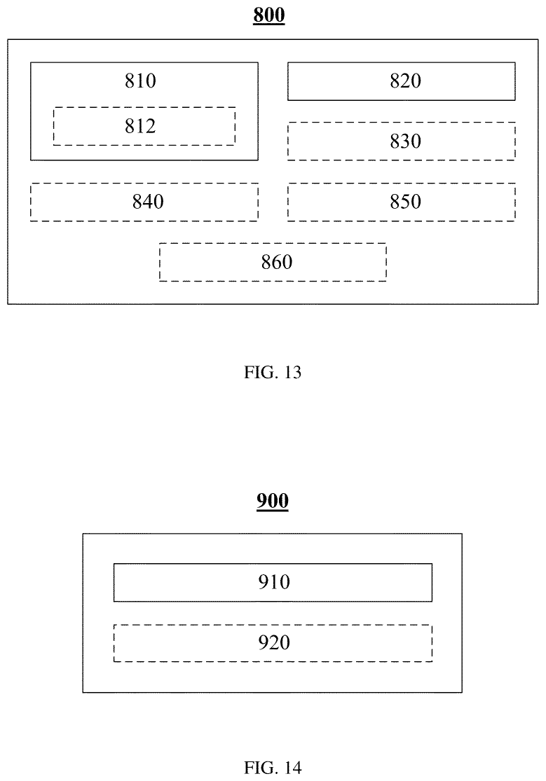

FIG. 13 is a schematic block diagram illustrating an apparatus 800 according to an example embodiment of the present disclosure. The apparatus 800 may be implemented to comprise or to form at least a part of the second device 303 discussed above to perform operations related to the second device 303. Since the operations related to the second device 303 have been discussed above with reference to FIGS. 1-11, the blocks of the apparatus 800 will be described briefly here and details thereof may refer to the above description.

Referring to FIG. 13, the apparatus 800 may include a first means 810 for over-sampling a first positioning reference signal PRS1 and a second positioning reference signal PRS2 in response to an over-sampling indication indicative of over-sampling being applied to positioning reference signals, and a second means 820 for transmitting to the first device 301 the first positioning reference signal PRS1 on a first component carrier CC1 and the second positioning reference signal PRS2 on a second component carrier CC2.

In an example embodiment, the first means 810 may include a first sub-means 812 for zero-padding resource elements at either side of the first positioning reference signal PRS1 and the second positioning reference signal PRS2 in the frequency domain to at least a bandwidth equal to a total bandwidth of the first component carrier CC1 and the second component carrier CC2.

In an example embodiment, the first device 301 may be a terminal device, and the second device 303 may be a network device. The over-sampling indication may be received from the location server 305. In another example embodiment, the first device 301 may be a network device, and the second device 303 may be a terminal device. The over-sampling indication may be received from the location server 305 or from the first device 301. In an example, the over-sampling indication may further comprise information of an over-sampling factor for over-sampling the first positioning reference signal PRS1 and the second positioning reference signal PRS2.

In an example embodiment, the first means 810 may further include a third means 830 for receiving from the first device 301 at least one of a frequency flatness probability for the first component carrier CC1 and the second component carrier CC2, a first phase compensation factor for the first component carrier CC1, or a second phase compensation factor for the second component carrier CC2.

In an example embodiment, the first means 810 may further include a fourth means 840 for applying the first phase compensation factor and the second phase compensation factor for subsequent transmissions of the first positioning reference signal PRS1 and the second positioning reference signal PRS2, respectively.

In an example embodiment, the first means 810 may further include a fifth means 850 for receiving from the first device 301 a third positioning reference signal PRS3 on the first component carrier CC1 and a fourth positioning reference signal PRS4 on the second component carrier CC2, and a sixth means 860 for applying the first phase compensation factor and the second phase compensation factor to compensate phases of the third positioning reference signal PRS3 and the fourth positioning reference signal PRS4, respectively. In an example, the first positioning reference signal PRS1 and the second positioning reference signal PRS2 are downlink positioning reference signals, and the third positioning reference signal PRS3 and the fourth positioning reference signal PRS4 are uplink sounding reference signals. In another example, the first positioning reference signal PRS1 and the second positioning reference signal PRS2 are uplink sounding reference signals, and the third positioning reference signal PRS3 and the fourth positioning reference signal PRS4 are downlink positioning reference signals.

FIG. 14 is a schematic block diagram illustrating an apparatus 900 according to an example embodiment of the present disclosure. The apparatus 900 may be implemented to comprise or to form at least a part of the location server 305 discussed above to perform operations related to the location server 305. Since the operations related to the location server 305 have been discussed above with reference to FIGS. 1-11, the blocks of the apparatus 900 will be described briefly here and details thereof may refer to the above description.

Referring to FIG. 14, the apparatus 900 may include a first means 910 for transmitting an over-sampling indication indicative of over-sampling being applied to positioning reference signals to at least one of a network device or a terminal device. In an example, the over-sampling indication may further comprise information of an over-sampling factor for over-sampling the positioning reference signals.

In an example embodiment, the apparatus 900 may further comprise a second means 920 for receiving from at least one of the network device or the terminal device, at least one of a frequency flatness probability for a first component carrier CC1 and a second component carrier CC2, a first phase compensation factor for the first component carrier CC1, or a second phase compensation factor for the second component carrier CC2.

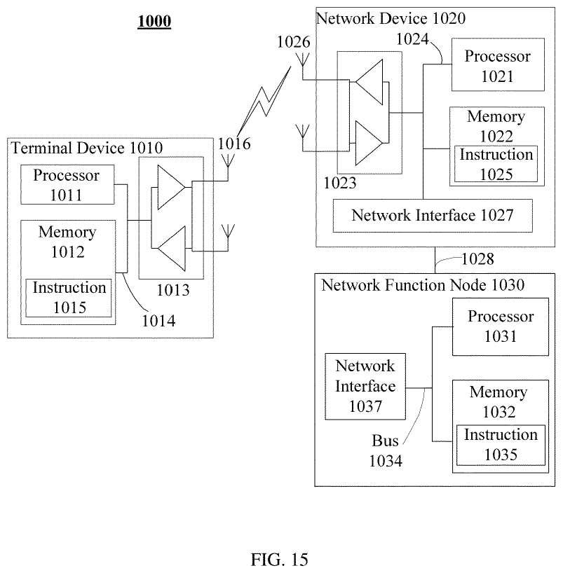

FIG. 15 is a block diagram illustrating an example communication system 1000 in which embodiments of the present disclosure can be implemented. As shown in FIG. 15, the communication system 1000 may comprise a terminal device 1010 which may be implemented as the UE 110 shown in FIG. 1, a network device 1020 which may be implemented as any one of the base stations 120 shown in FIG. 1, and a network function node 1030 which may be implemented as the location server 130 shown in FIG. 1.

Referring to FIG. 15, the terminal device 1010 may comprise one or more processors 1011, one or more memories 1012 and one or more transceivers 1013 interconnected through one or more buses 1014. The one or more buses 1014 may be address, data, or control buses, and may include any interconnection mechanism such as series of lines on a motherboard or integrated circuit, fiber, optics or other optical communication equipment, and the like. Each of the one or more transceivers 1013 may comprise a receiver and a transmitter, which are connected to one or more antennas 1016. The terminal device 1010 may wirelessly communicate with the network device 1020 through the one or more antennas 1016. The one or more memories 1012 may include instructions 1015 which, when executed by the one or more processors 1011, may cause the terminal device 1010 to perform operations and procedures relating to the UE 110 as described above.

The network device 1020 may comprise one or more processors 1021, one or more memories 1022, one or more transceivers 1023 and one or more network interfaces 1027 interconnected through one or more buses 1024. The one or more buses 1024 may be address, data, or control buses, and may include any interconnection mechanism such as a series of lines on a motherboard or integrated circuit, fiber, optics or other optical communication equipment, and the like. Each of the one or more transceivers 1023 may comprise a receiver and a transmitter, which are connected to one or more antennas 1026. The network device 1020 may operate as a base station for the terminal device 1010 and wirelessly communicate with terminal device 1010 through the one or more antennas 1026. The one or more network interfaces 1027 may provide wired or wireless communication links through which the network device 1020 may communicate with other network devices, entities, elements or functions. For example, the network device 1020 may communicate with the network function node 1030 via backhaul connections 1028. The one or more memories 1022 may include instructions 1025 which, when executed by the one or more processors 1021, may cause the network device 1020 to perform operations and procedures relating to any one of the base stations 120.

The network function node 1030 may comprise one or more processors 1031, one or more memories 1032, and one or more network interfaces 1037 interconnected through one or more buses 1034. The one or more buses 1034 may be address, data, or control buses, and may include any interconnection mechanism such as a series of lines on a motherboard or integrated circuit, fiber, optics or other optical communication equipment, and the like. The network function node 1030 may operate as a core network function node and wired or wirelessly communicate with the network device 1020 through one or more links. The one or more network interfaces 1037 may provide wired or wireless communication links through which the network function node 1030 may communicate with other network devices, entities, elements or functions. The one or more memories 1032 may include instructions 1035 which, when executed by the one or more processors 1031, may cause the network function node 1030 to perform operations and procedures relating to the location server 130 as described above.

The one or more processors 1011, 1021 and 1031 discussed above may be of any appropriate type that is suitable for the local technical network, and may include one or more of general purpose processors, special purpose processor, microprocessors, a digital signal processor (DSP), one or more processors in a processor based multi-core processor architecture, as well as dedicated processors such as those developed based on Field Programmable Gate Array (FPGA) and Application Specific Integrated Circuit (ASIC). The one or more processors 1011, 1021 and 1031 may be configured to control other elements of the UE/network device/network element and operate in cooperation with them to implement the procedures discussed above.

The one or more memories 1012, 1022 and 1032 may include at least one storage medium in various forms, such as a transitory memory and/or a non-transitory memory. The transitory memory may include, but not limited to, for example, a random access memory (RAM) or a cache. The non-transitory memory may include, but not limited to, for example, a read only memory (ROM), a hard disk, a flash memory, and the like. The term “non-transitory,” as used herein, is a limitation of the medium itself (i.e., tangible, not a signal) as opposed to a limitation on data storage persistency (e.g., RAM vs. ROM). Further, the one or more memories 1012, 1022 and 1032 may include but not limited to an electric, a magnetic, an optical, an electromagnetic, an infrared, or a semiconductor system, apparatus, or device or any combination of the above.

It would be understood that blocks in the drawings may be implemented in various manners, including software, hardware, firmware, or any combination thereof. In some embodiments, one or more blocks may be implemented using software and/or firmware, for example, machine-executable instructions stored in the storage medium. In addition to or instead of machine-executable instructions, parts or all of the blocks in the drawings may be implemented, at least in part, by one or more hardware logic components. For example, and without limitation, illustrative types of hardware logic components that can be used include Field-Programmable Gate Arrays (FPGAs), Application-Specific Integrated Circuits (ASICs), Application-Specific Standard Products (ASSPs), System-on-Chip systems (SOCs), Complex Programmable Logic Devices (CPLDs), etc.

Some exemplary embodiments further provide program instruction or instructions which, when executed by one or more processors, may cause a device or apparatus to perform the procedures described above. The program instruction for carrying out procedures of the exemplary embodiments may be written in any combination of one or more programming languages. The program instruction may be provided to one or more processors or controllers of a general purpose computer, special purpose computer, or other programmable data processing apparatus, such that the program instruction, when executed by the processor or controller, cause the functions/operations specified in the flowcharts and/or block diagrams to be implemented. The program instruction may execute entirely on a machine, partly on the machine, as a stand-alone software package, partly on the machine and partly on a remote machine or entirely on the remote machine or server.

Some exemplary embodiments further provide a computer program product or a computer readable medium having the program instruction or instructions stored therein. The computer readable medium may be any tangible medium that may contain, or store a program for use by or in connection with an instruction execution system, apparatus, or device. The machine readable medium may be a machine readable signal medium or a machine readable storage medium. A machine readable medium may include but is not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the subject matter has been described in a language that is specific to structural features and/or method actions, it is to be understood the subject matter defined in the appended claims is not limited to the specific features or actions described above. On the contrary, the above-described specific features and actions are disclosed as an example of implementing the claims.

1. A first device in a communication network comprising:
at least one processor; and
at least one memory storing instructions that, when executed by the at least one processor, cause the first device at least to:
receive from a second device in the communication network, a first positioning reference signal on a first component carrier and a second positioning reference signal on a second component carrier; and
jointly process the first positioning reference signal and the second positioning reference signal to generate a positioning measurement in response to an over-sampling indication indicative of over-sampling being applied to positioning reference signals.

2. The first device of claim 1, wherein the first device is a terminal device, the second device is a network device, the first positioning reference signal and the second positioning reference signal are downlink positioning reference signals, and the over-sampling indication is received from a location server in the communication network or from the second device.

3. The first device of claim 1, wherein the first device is a network device, the second device is a terminal device, the first positioning reference signal and the second positioning reference signal are sounding reference signals, and the over-sampling indication is received from a location server in the communication network.

4. The first device of claim 1, wherein the over-sampling indication further comprises information associated with an over-sampling factor for the first positioning reference signal and the second positioning reference signal.

5. The first device of claim 4, wherein the at least one memory further stores instructions that, when executed by the at least one processor, cause the first device at least to:
over-sample the first positioning reference signal and the second positioning reference signal in the time domain in response to the over-sampling indication, before jointly processing the first positioning reference signal and the second positioning reference signal.

6. The first device of claim 5, wherein over-sampling the first positioning reference signal and the second positioning reference signal in the time domain comprises:
zero-padding resource elements at either side of the first positioning reference signal and the second positioning reference signal in the frequency domain to at least a bandwidth indicated by the over-sampling factor; and
converting the zero-padded first positioning reference signal and the zero-padded second positioning reference signal from the frequency domain to the time domain.

7. The first device of claim 1, wherein jointly processing the first positioning reference signal and the second positioning reference signal comprises:
compensating a phase offset between the first component carrier and the second component carrier; and
applying frequency shift on the first positioning reference signal and the second positioning reference signal to obtain a continuous positioning reference signal spectrum in baseband from the received first positioning reference signal and the received second positioning reference signal.

8. The first device of claim 7, wherein the frequency shift is applied to concatenate the first positioning reference signal and the second positioning reference signal at a central frequency between the first positioning reference signal and the second positioning reference signal in the frequency domain, and a frequency spacing between the first positioning reference signal and the second positioning reference signal caused by a white space or a guard band between the first component carrier and the second component carrier is removed when the frequency shift is applied in baseband.

9. The first device of claim 7, wherein compensating the phase offset between the first component carrier and the second component carrier comprises:
estimating a first phase of the first component carrier and a second phase of the second component carrier; and
applying a first phase compensation factor to compensate the first phase of the first component carrier and a second phase compensation factor to compensate the second phase of the second component carrier.

10. The first device of claim 9, wherein estimating the first phase of the first component carrier and the second phase of the second component carrier comprises:
estimating a first propagation delay of the first component carrier and a second propagation delay of the second component carrier on a first arrival path from the second device to the first device; and
determining the first phase of the first component carrier associated with the first propagation delay and the second phase of the second component carrier associated with the second propagation delay.

11. The first device of claim 9, wherein estimating the first phase of the first component carrier and the second phase of the second component carrier comprises:
unwrapping in the frequency domain, a first phase response of the first positioning reference signal and a second phase response of the second positioning reference signal, in a case where a first direct current subcarrier of the first component carrier is configured for the first positioning reference signal and a second direct current subcarrier of the second component carrier is configured for the second positioning reference signal; and
performing linear interpolation on the first phase response and the second phase response to determine a phase corresponding to the first direct current subcarrier of the first component carrier as the first phase of the first component carrier and a phase corresponding to the second direct current subcarrier of the second component carrier as the second phase of the second component carrier.

12. The first device of claim 9, wherein the at least one memory further stores instructions that, when executed by the at least one processor, cause the first device at least to:
perform a frequency flatness check on the first component carrier and the second component carrier to determine a frequency flatness probability; and
determine the first phase compensation factor and the second phase compensation factor at least based on the first phase of the first component carrier, the second phase of the second component carrier and whether the frequency flatness probability is higher than or equal to a threshold.

13. The first device of claim 12, wherein the threshold is configured from the second device when the first device is a terminal device and the second device is a network device serving the terminal device, or from a location server in the communication network.

14. The first device of claim 12, wherein the at least one memory further stores instructions that, when executed by the at least one processor, cause the first device at least to:
report to at least one of the second device or a location server in the communication network, at least one of the following: the frequency flatness probability, the first phase compensation factor for the first component carrier, or the second phase compensation factor for the second component carrier.

15. The first device of claim 12, wherein the at least one memory further stores instructions that, when executed by the at least one processor, cause the first device at least to:
apply the first phase compensation factor and the second phase compensation factor to compensate a third positioning reference signal and a fourth positioning reference signal, respectively; and
transmit to the second device, the compensated third positioning reference signal on the first component carrier and the compensated fourth positioning reference signal on the second component carrier.

16. The first device of claim 15, wherein the at least one memory further stores instructions that, when executed by the at least one processor, cause the first device at least to:
inform the second device of the phase compensation made to the third positioning reference signal and the fourth positioning reference signal.

17. The first device of claim 15, wherein the first positioning reference signal and the second positioning reference signal are downlink positioning reference signals, and the third positioning reference signal and the fourth positioning reference signal are uplink sounding reference signals, or
the first positioning reference signal and the second positioning reference signal are uplink sounding reference signals, and the third positioning reference signal and the fourth positioning reference signal are downlink positioning reference signals.

18. A second device in a communication network comprising:
at least one processor; and
at least one memory storing instructions that, when executed by the at least one processor, cause the second device at least to:
over-sample a first positioning reference signal and a second positioning reference signal in response to an over-sampling indication indicative of over-sampling being applied to positioning reference signals; and
transmit to a first device in the communication network, the first positioning reference signal on a first component carrier and the second positioning reference signal on a second component carrier.

19. The second device of claim 18, wherein over-sampling the first positioning reference signal and the second positioning reference signal comprises:
zero-padding resource elements at either side of the first positioning reference signal and the second positioning reference signal in the frequency domain to at least a bandwidth equal to a total bandwidth of the first component carrier and the second component carrier; and
converting the zero-padded first positioning reference signal and the zero-padded second positioning reference signal from the frequency domain to the time domain.

20. The second device of claim 18, wherein the first device is a terminal device, the second device is a network device, the first positioning reference signal and the second positioning reference signal are downlink positioning reference signals, and the over-sampling indication is received from a location server in the communication network.

21.-64. (canceled)
